(19) United States
(12) Patent Application Publication
(10) Pub. No.: US 2026/0005640 A1
(43) Pub. Date: Jan. 1, 2026

(54) AUTOMATED PILE MARKER

(71) Applicant: Terabase Energy, Inc., Berkeley, CA (US)

(72) Inventors: Brandon Roy Hunter, Winters, CA (US); Adam Hansel, Davis, CA (US); Soren Jensen, Corte Madera, CA (US)

(73) Assignee: Terabase Energy, Inc., Berkeley, CA (US)

(21) Appl. No.: 19/319,343

(22) Filed: Sep. 4, 2025

Related U.S. Application Data
(63) Continuation-in-part of application No. 18/208,038, filed on Jun. 9, 2023.

(51) Int. Cl. H02S 20/10; G01C 9/06; G01C 15/10; G01D 11/30

(52) U.S. Cl. CPC H02S 20/10; G01C 9/06; G01D 11/30; G01C 2009/066; G01C 15/105

(57) ABSTRACT

In a large construction site, it can be challenging to maintain precise installation for multiple piles. If the piles are not installed accurately, subsequent installation process may have to be changed, adjusted, or adapted due to the actual pile construction. System and method embodiments of pile marking for subsequent bracket installation are disclosed. A laser marker is installed on a pile in a row of piles to emit one or more laser projections onto a pile to generate one or more marks based on one or more offsets that are established during piles scanning and validation. These marks may be used to ensure correct subsequent bracket and solar table installation.

### CROSS-REFERENCE TO RELATED APPLICATIONS

This application is a continuation-in-part of U.S. patent application Ser. No. 18/208,038 (Docket No. 20179-2661US), filed on Jun. 9, 2023, entitled “SYSTEMS AND METHODS FOR FOUNDATION MAPPING AND REMEDIATION”, and listing Adam Hansel and Soren Jensen as inventors. The aforementioned patent document is incorporated by reference herein in its entirety.

### TECHNICAL FIELD

The present disclosure relates generally to pile mapping and pile marking. More particularly, the present disclosure relates to pile markers to facilitate on-site pile installation for large construction sites.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to improve on-site installation efficiency during the construction process.

In a large construction site, e.g., a large-scale solar farm construction site, tens of thousands of piles are driven into the ground to provide a foundation for a solar racking system. The placement and orientation of the piles are vital for the subsequent installation of the solar racking system. The installation tolerances of the piles are typically ±1.25 inch vertically and up to ±1.5 to 3 inches in the lateral directions. Piles are typically installed with twist tolerances on the order of 1.0° to 3° and up to 3° to 5° dependent on direction. If the piles are not installed consistently or accurately, subsequent solar tracker table installation process may have to be changed, adjusted, or adapted due to the actual pile construction.

It can be very challenging to maintain consistent installation processes at each point of installation within a construction site across large areas. If the piles are not installed consistently or accurately, the subsequent installation process may have to be changed, adjusted, or adapted due to the actual pile construction. In the worst scenario, the subsequent installation process may even become impossible if the piles are installed poorly and the piles will have to be remediated or reinstalled.

Validating the installed piles is a very complex and laborious process even with modern advanced technology like Differential Global Positioning System (DGPS) or Total Stations. At least three points are needed on each pile to accurately determine its location and orientation. Given the large number of piles in a construction site, it is very time-consuming to manually validate the installation accuracy of each pile, let alone provide effective remediation when one or more piles have installation deviations.

Furthermore, installation of preassembled solar tracker tables raises challenges for aligning the tables during installation. With a traditional manual “stick built” method, a tracker row is aligned after all torque tubes and bearing housing assemblies (BHAs) are “dryfit”, put in place but only with finger tightened fasteners. The alignment process is done visually by looking down the dryfit row from one end and then signal to a team of workers who work from the opposite end and adjusts the position of each of the BHA's as directed by the aligner. This method is impractical or impossible when installing a fully assembled solar table as done with automated assembly processes. The assembled modules add 500-8001b of weight, thus creating a safety risk if a tracker is only assembled with finger tight fasteners. The modules also partially obscure the view of the torque tubes which makes the alignment challenging.

What is needed are systems, devices and methods for effective pile mapping and marking to improve on-site installation efficiency of solar racking systems in large construction sites.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 shows a three-dimensional (3D) scanning for multiple installed piles in a construction site in accordance with various embodiments of the invention.

FIG. 2 is a perspective view of a pile in accordance with various embodiments of the invention.

FIG. 3A is a perspective view for an actual scan of a pile field in accordance with various embodiments of the invention.

FIG. 3B is a perspective view of a point cloud for an installed pile in accordance with various embodiments of the invention.

FIG. 4 is a process of pile scanning and validation in accordance with various embodiments of the invention.

FIG. 5 is a perspective view of default markers and adjusted markers on an installed pile in accordance with various embodiments of the invention.

FIG. 6A is a perspective view of a bracket installed on a pile based on an adjusted marker in accordance with various embodiments of the invention.

FIG. 6B is a perspective view of a coupler bracket installed on a pile based on an adjusted marker in accordance with various embodiments of the invention.

FIG. 7 is a perspective view of a torque tube installed on a row of piles via multiple brackets in accordance with various embodiments of the invention.

FIG. 8 is a process of marking installed piles for bracket mounting in accordance with various embodiments of the invention.

FIG. 9 is an alternative process of remediating installed piles in accordance with various embodiments of the invention.

FIG. 10 is a simplified block diagram of a computing device in accordance with various embodiments of the invention.

FIG. 11 is a schematic of a laser marker for pile marking in proximity to a pile in accordance with various embodiments of the invention.

FIG. 12 is a perspective view of a laser marker installed on a pile for pile marking in accordance with various embodiments of the invention.

FIG. 13 is a top view of a pair of BHA brackets installed on a pile to compensate for a twist offset in accordance with various embodiments of the invention.

FIG. 14 is a perspective view of solar table alignment verification in accordance with various embodiments of the invention.

FIG. 15 is a process of pile marking in accordance with various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of embodiments for foundation mapping and/or remediation.

Furthermore, connectivity between components or systems within the figures is not intended to be limited to direct connections. Also, components may be integrated together or be discrete prior to construction of a foundation mapping and/or remediation system.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or steps may be optional; (2) components or steps may not be limited to the specific description set forth herein; (3) certain components or steps may be assembled/combined differently; and (4) certain steps may be performed concurrently or in sequence.

Furthermore, it shall be noted that many embodiments described herein are given in the context of the assembly and installation of large numbers of solar panels within a system, but one skilled in the art shall recognize that the teachings of the present disclosure may apply to other large and complex construction sites other than solar farms.

In this document, “a large-scale solar farm” may be referred to as a solar power plant site having hundreds or more piles as construction foundations. The word “pile” refers to a grounded pole, column, or beam partially inserted into ground and served as a foundation for subsequent constructions, such as brackets and/or torque tubes for a solar system. The term “solar table” refers to a structural assembly comprising one or more photovoltaic (PV) modules and/or one or more torque tubes (or purlins) for PV module support. Some types of solar tables may have electrical harnesses and supplemental structure that allows them to connect to other solar tables or foundations/piles while other types do not have this supplemental structure.

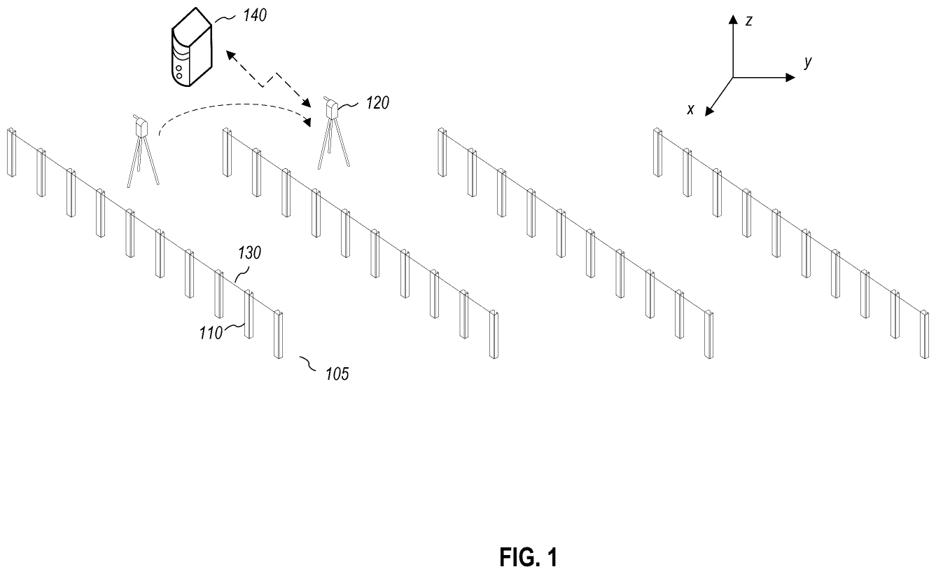

FIG. 1 shows a three-dimensional (3D) scanning for multiple installed piles in a construction site in accordance with various embodiments of the invention. A plurality of piles are installed in a pattern of one or more rows, with each row 105 comprising multiple piles 110 to accommodate subsequent installations. For example, each row may be used to securely support a torque tube 130, on which multiple solar panels may be installed. Each row may have 10-15 piles spanning a distance of 350-450 feet. The rows are typically separated up to 22 feet.

The multiple piles in each row have to meet one or more predetermined installation tolerances, e.g., a vertical (z-direction) deviation, a lateral (x-direction and/or y-direction) deviation, orientation deviation, etc., such that the torque tube may be securely installed on each pile. The installation tolerances of the piles are typically ±1.25 inch vertically, up to ±1.5 to 3 inches in the lateral directions, and up to 3° to 5° for twist toleration.

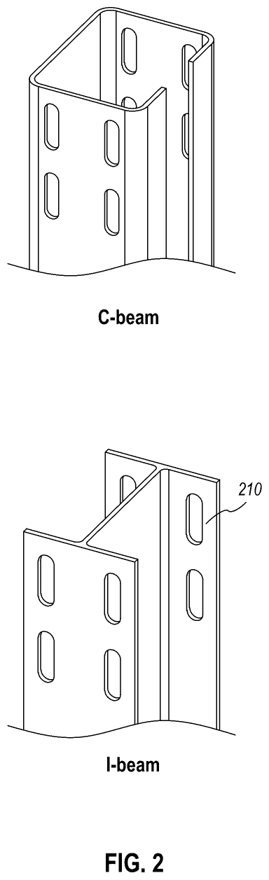

FIG. 2 is a perspective view of a pile in accordance with various embodiments of the invention. The pile is typically made from I-beams having a W-profile (or H-profile) or a C-beam having a C-profile. The pile may comprise a plurality of slots or holes 210 to facilitate the installation of brackets for torque tube support. The piles may have varied lengths and sizes, with a typical length of 4-8 feet above ground and 4-15 feet embedded underground.

Referring to FIG. 1, to validate the installed piles, a 3D scanner 120 is used to scan the plurality of piles to create a point cloud for each pile in each row. For better scanning, the scanner may scan one area, e.g., two to four rows, at a time and then move to a different location, as shown in FIG. 1, to scan another area. It shall be noted that partial rows scanning may also be performed once a time, with scanning results integrated together afterwards in post-scanning data processing. The 3D scanner may be a light detection and ranging (LIDAR) scanner with an accuracy of 3/32-⅛″ (2-3 mm) over distances of 500 feet. The point clouds for the plurality of piles may be stored locally within the 3D scanner or stored in a separate storage. The point clouds for the plurality of piles are accessible by a computing device 140, which may be a workstation (e.g., a laptop) deployed on-site, a server that couples to the 3D scanner, a cloud server, or an embedded computer in a mobile device that can be carried by a LIDAR operator, for further processing.

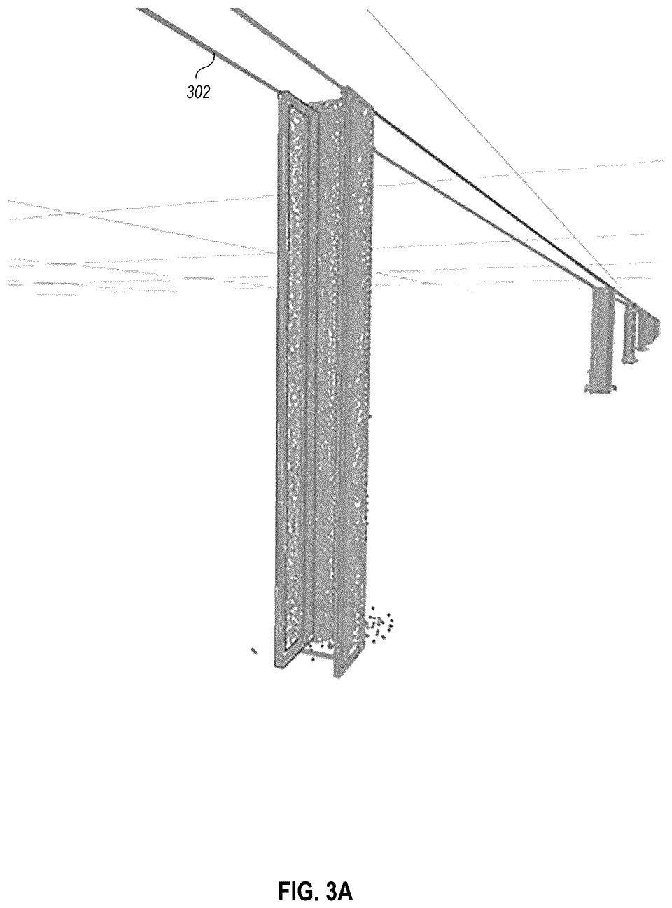

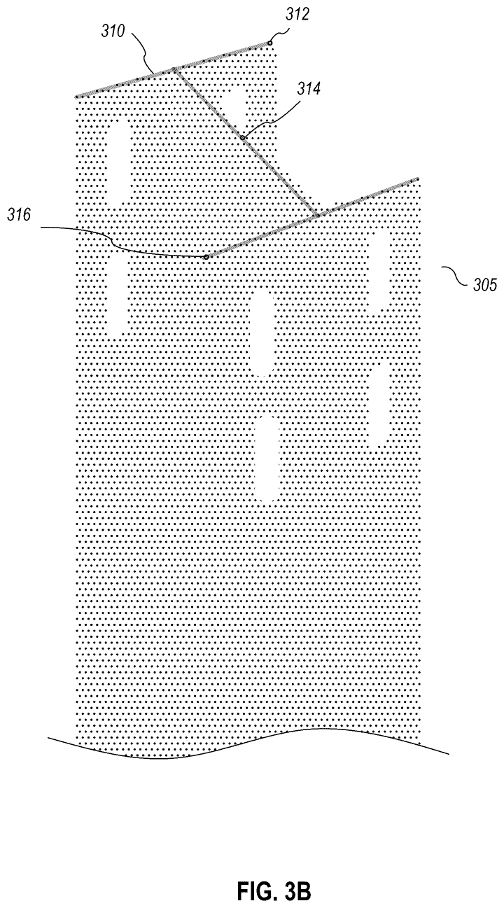

FIG. 3A is a perspective view for actual scanning of a pile field in accordance with various embodiments of the invention. One or more laser ejections 302 are used for scanning along a row of piles or cross piles at different rows for measurements. FIG. 3B depicts a point cloud for a pile in accordance with various embodiments of the invention. The point cloud 305 comprises a plurality of date points, as shown FIG. 3B, with the number of data points depending on scanning resolution and pile specification (high, width, etc.).

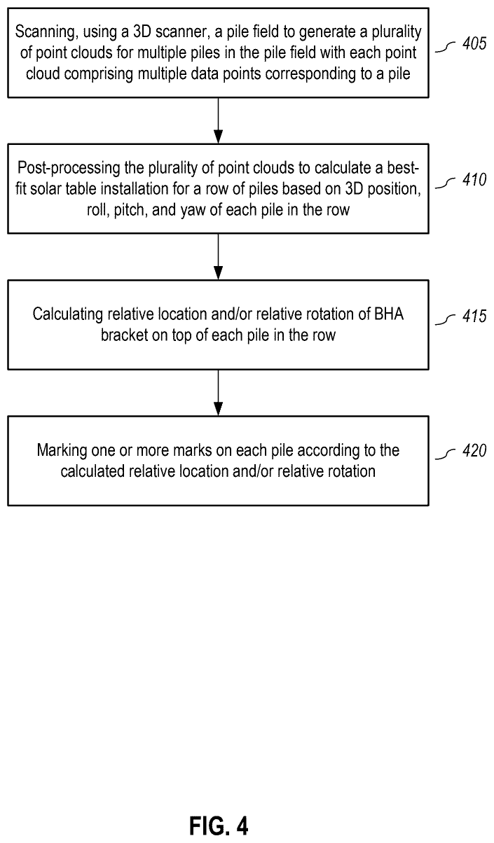

FIG. 4 is a process of pile scanning and validation in accordance with various embodiments of the invention. In step 405, a pile field comprising a plurality of piles are scanned using a 3D scanner, e.g., a commercial Lidar unit or other applicable scanning device, to generate a plurality of point clouds for multiple piles in a pile row, with each point cloud comprising multiple data points corresponding to a pile. Such a scanning process may require multiple scans at different locations.

In step 410, a computing device performs post-processing for the plurality point clouds to calculate a best-fit solar table installation scheme for the pile row based on 3D position (x, y, and z coordinates), pile roll, pile pitch, and pile yaw of each pile in the pile row derived from the plurality of point clouds. It shall be noted that the “best-fit solar table installation scheme” might not be limited to an installation of solar tables in a straight line. In certain embodiments, a best-fit solar table installation scheme may be an arrange of solar tables in an arrangement (e.g., a bent, a curve, etc.) other than a straight line. Such non-straight arrangement may be a result from geographic restriction (e.g., a ground with a slope) and may be realized through coupling of solar tables via one or more universal joint. Various algorithms may be adopted for such calculation, including extracting and fitting characteristics of a pile to identify important features of exposed section of the pile to determine installation parameters. The features may be edges, intersection of edges, ends of edges, corners, holes, or slots in the pile.

For example, the computing device may identify one or more characteristic data points among the multiple data points in each point cloud and then use one or more characteristic data points to perform the calculation. As shown in FIG. 3B, the computing device derives the geometry of a pile using algorithms including averaging and filtering of data points that are deemed erroneous. The computing device may identify characteristic data points, e.g., data points 312, 314, and 316 on a top layer 310 of the point cloud 305. The data point 314 may be a geometry center of the top layer and used to identify pile positions in x, y, and z coordinates for the pile. The data points 312 and 316 may be two data points at opposite corners of the top layer and used, together with the data point 314, to identify pile roll, pile pitch, and pile yaw. One skilled in the art shall understand other characteristic data points, e.g., data points at different layers, may also be used for calculating installation parameters.

In one or more embodiments, the best-fit solar table installation scheme is calculated to minimize errors for installed pile locations vs tolerances based on the tracker manufacturer's allowed pile tolerances and the measured pile locations. In one or more embodiments, the desired goal for solar table installation is to minimize the errors. Regardless of where the piles are, as long as there is an axis (the theoretical torque tube axis) where bearings for solar tube coupling may be adjusted within available slots on each pile and adjustability means, the axis may be a legitimate solar table installation scheme. Accordingly, the tolerances may be handled with respect to the best fit axis.

In one or more embodiments, the best-fit solar table installation scheme may involve a remediation and re-installation scheme for one or more piles. Such remediation and re-installation scheme shall be used as a last resort when there is no applicable best-fit for solar table installation based on existing installed piles. It shall be noted that the pile row may need to be re-scanned after the remediation to validate pile position and generate in a best-fit solar table installation scheme without needing additional pile remediation and re-installation.

The solar table installation schemes may be generated using the same computing device that performs installation parameter calculation and parameter deviation determination or using a separate computing device specifically handling remediation generation. The remediation schemes may be re-installations for one or more piles that have at least one parameter deviation above a threshold, one or more offsets for subsequent installation positions on one or more piles, or a combination or both.

In step 415, location and orientation of BHA bracket for solar table coupling on top of each pile in the pile row are calculated based on the calculated best-fit solar table installation scheme such that the torque tube can be installed to the manufacturer's specifications on existing piles without remediation or re-installation. The best-fit solar table installation scheme establishes an axis along which the torque tube can be installed on the piles without exceeding installation specifications. For example, 12 of the 13 piles in a row are installed perfectly the 13th pile is installed 3.5″ too far to the east, which technically is out of specification. By making a torque tube axis 1.75″ to the east of the perfect 12 piles, all the pile locations may be within tolerance limits and thus solar table installation may be in specification.

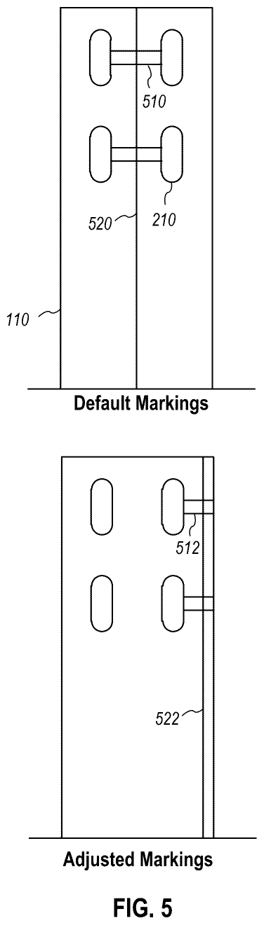

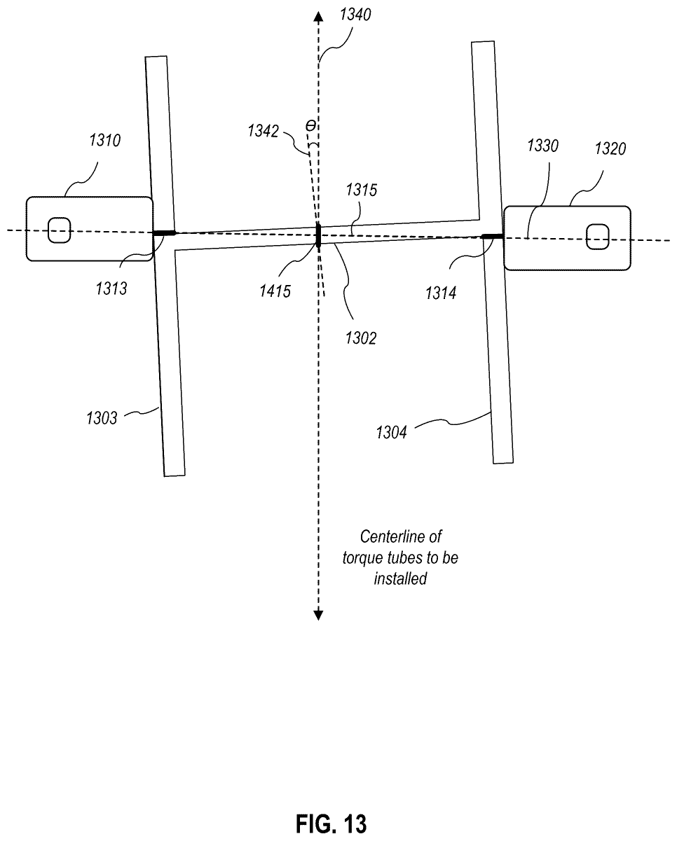

In step 420, one or more marks are marked on each pile in the pile row according to the calculated relative location and/or relative rotation of BHA brackets. The one or more marks may comprise one or more offsets with respect to default installation positions for BHA brackets. The default bracket installation positions are theoretical or idea installation positions under idea situation with parameters for each pile, such as designed pile positions, pile roll, pile pitch, and pile yaw are perfectly aligned to design specification. Ideally, the offsets would be zero when each pile is perfectly installed. Practically, due to inevitable installation errors, there always are some parameter deviations in one or more piles among the multiple piles in a row. The one or more offsets may comprise a center line mark as shown in FIG. 5, one or more twist marks as shown in FIG. 13.

FIG. 5 is a perspective view of default markers and adjusted markers on an installed pile in accordance with various embodiments of the invention. An installed pile 110 has one or more default positions for subsequent installation of one or more brackets on the pile under an ideal scenario where the pile is installed perfectly with no parameter deviations (or parameter deviations as zero). The pile 110 comprises one or more slots 210 that are used for subsequent bracket installation on the pile. The default positions may comprise one or more horizontal positions 510 and one or more vertical positions 520 that are used to identify one or more reference points/lines for subsequent installations on the pile. For example, the horizontal positions 510 may be a line of alignment for a top edge of a bracket. Alternatively, the horizontal positions 510 may be referred to as a horizontal coordinate of an installation point for a bracket.

When one or more parameter deviations are identified for the pile 110, subsequent bracket installations on the pile shall be changed or updated as indicated by one or more adjusted markings, which may comprise one or more adjusted horizontal markers 512 and/or one or more vertical markers 522 that are used to identify one or more adjusted reference points/lines for subsequent installations on the pile. The one or more adjusted horizontal markers are determined based on one or more offsets, e.g., offsets in x, y, and z coordinates with respect to the one or more default markers.

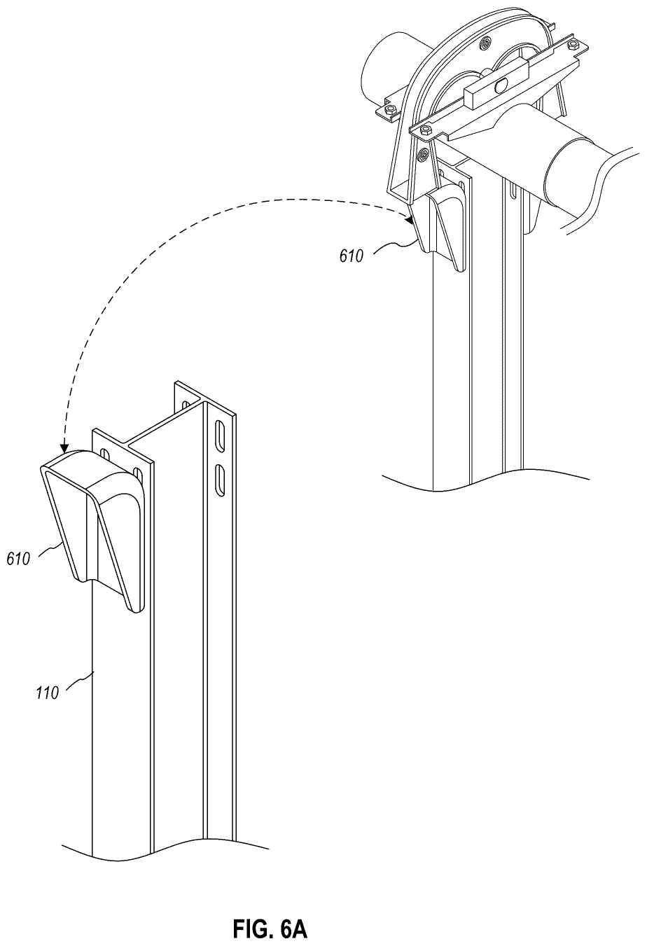

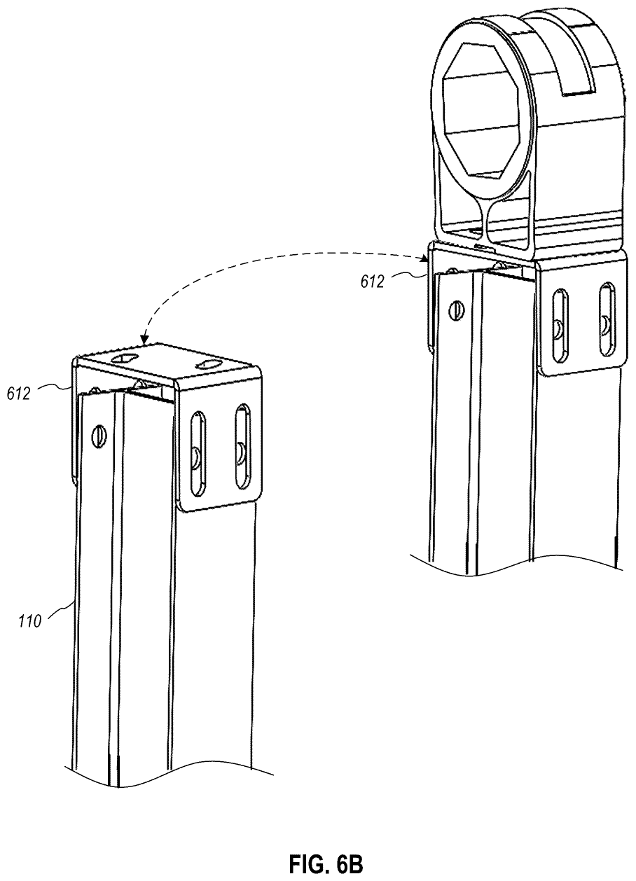

FIG. 6A depicts a perspective view of a bracket 610 installed on a pile 110 based on adjusted markers in accordance with various embodiments of the invention. The bracket 610 is installed on each flange of the pile to support a BHA bearing. FIG. 6B depicts a perspective view of a coupler bracket 612 installed on a pile 110 based on adjusted markers in accordance with various embodiments of the invention. The coupler bracket 612 is installed on both flanges of the pile to support a BHA bearing.

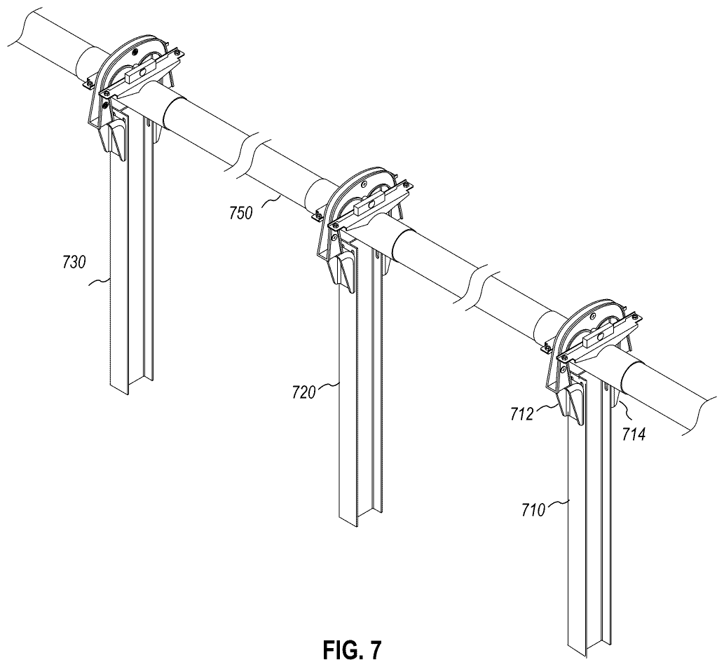

FIG. 7 is a perspective view of a torque tube 750 installed on a row of piles comprising multiple piles 710, 720, 730, etc., via multiple brackets, e.g., 712, 714, in accordance with various embodiments of the invention. The torque tubes need to be installed in straight even though some piles may be installed with parameter deviations to minimize torque tube stresses caused by bending during the tracking cycle of rotation to move solar panels to follow the Sun's path. With well-designed and well-implemented pile installation, pile remediation or re-installation may be avoided, and installation efficiency of torque tubes/tables may be improved. Mounted by the adjusted markings for bracket installations, the torque tube 750 may still be installed, within a torque tube installation tolerance, on the multiple piles 710, 720, 730, even though some piles are installed with parameter deviations. Therefore, pile re-installation may be avoided, installation efficiency may be improved, and construction costs may be decreased.

Typically, a slew drive (not shown in FIG. 7) is located in the middle of a row of piles (e.g., on pile 720) for load balancing. The slew drive enables rotational movement of torque tubes on one or both sides such that all solar modules installed on the row of tables can be tilted simultaneously.

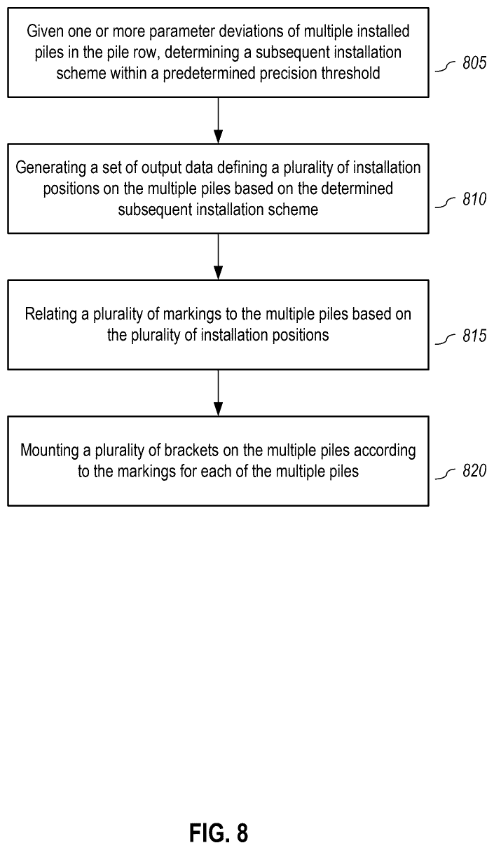

FIG. 8 is a process of marking installed piles for bracket mounting in accordance with various embodiments of the invention. In step 805, given one or more parameter deviations of multiple installed piles in the pile row, a second computing device determines a subsequent installation scheme, e.g., a torque tube installation scheme, within a predetermined precision threshold (e.g., a tube level and tube angle precision) such that the torque tube can be installed on the multiple installed piles. The second computing device may or may not be the same computing device that performs installation parameter calculation. In some embodiments, the subsequent installation scheme is determined with a priority for a highest precision for the subsequent installation scheme. In some other embodiments, the subsequent installation scheme may be determined with a priority of a highest possible precision within the predetermined precision threshold to engage all of the multiple piles for subsequent installation without requiring any pile re-installation/remediation. For example, the second computing device may choose a torque tube installation scheme with a precision of 3° orientation deviation (within a 5° threshold) to engage all installed piles for torque tube installation instead of choosing a torque tube installation scheme with a precision of 0.5° orientation deviation but not capable of engaging all installed piles. In one or more embodiments, the second computing device may use various algorithms, such as linear or polynomial interpolating, to determine the subsequent installation scheme.

In step 810, the second computing device generates a set of output data defining a plurality of installation positions on the multiple piles based on the determined subsequent installation scheme. The set of output data comprises one or more offsets for one or more installation parameters for one or more piles, among the multiple piles in a row. The one or more offsets may be applicable to one or more piles that have parameter deviations, to one or more piles that do not have parameter deviations, or to a mixture of piles with parameter deviations and without parameter deviations.

In step 815, a plurality of markings is related to the multiple piles based on the plurality of installation positions. Markings on one pile may be default markings, adjusted markings with offsets for default markings, or a combination of both. In one or more embodiments, the markings may be physical marks marked using a pile marker, which may be placed on top of a pile to mark bracket mounting positions on the pile. In other embodiments, the marks may be fed into autonomous installation equipment, e.g., an automated rover, to facilitate automatic installations. The pile marker may have a built-in Global Positioning System (GPS) or similar location sensor to automatically identify location, pile ID and position of markings for that specific pile, as well as determine whether the pile has been marked. Alternatively, the pile location/identification may be manually checked using a look-up table. During the look-up, the pile location and/or identification (ID) may be used to extract marking locations for that pile. For example, an individual pile may be identified using a GPS system or manual lookup. Based on an ID of the pile, one or more marking positions may be recalled from the calculations and marked on the pile either automatically or manually. In step 820, a plurality of brackets are mounted on the multiple piles according to the markings for each of the multiple piles.

In one or more embodiments, the one or more parameter deviations of multiple installed piles may be excessive. As a result, the second computing device may not be able to determine a subsequent installation scheme within a predetermined precision threshold for the multiple installed piles. As a result, the second computing device may need to propose a subsequent installation scheme involving re-installation of one or more piles.

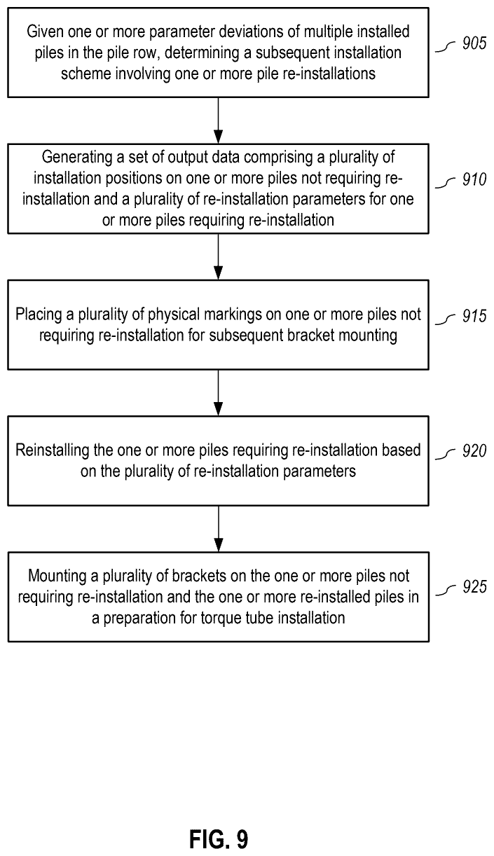

FIG. 9 is an alternative process of remediating installed piles involving pile re-installation in accordance with various embodiments of the invention. In step 905, given one or more parameter deviations of multiple installed piles in the pile row, the second computing device determines a subsequent installation scheme involving one or more pile re-installations/remediations to accommodate a torque tube installation within a predetermined precision threshold. In some embodiments, the subsequent installation scheme is determined with a priority for the highest precision for the subsequent installation/remediation scheme. In some other embodiments, the subsequent installation/remediation scheme may be determined with a priority of minimum pile re-installation/remediation to meet the predetermined precision threshold.

In step 910, based on the determined subsequent installation scheme, the second computing device generates a set of output data comprising a plurality of installation positions on one or more piles, among the multiple piles, not requiring re-installation, and a plurality of re-installation parameters for one or more piles, among the multiple piles, requiring re-installation. The plurality of installation positions may comprise one or more offsets for one or more installation parameters for piles not requiring reinstallation.

In step 915, a plurality of physical markings are placed, based on the plurality of installation positions, on one or more piles not requiring re-installation for subsequent bracket mounting. In step 920, the one or more piles requiring re-installation/remediation are re-installed/remediated based on the plurality of re-installation/remediation parameters. In one or more embodiments, the remediated/re-installed pile needs to be re-scanned to ensure that the new position falls within required installation tolerances and to check whether the subsequent installation scheme is still valid. The re-scanning may be implemented only to the remediated/re-installed pile if the scanning device is not moved during the remediation/re-installation process, or to the entire pile row to confirm that the subsequent installation scheme is valid for the installed/remediated piles. If the subsequent installation scheme is no longer valid, a new “best fit” axis may need to be calculated again.

In step 925, a plurality of brackets are mounted on one or more piles not requiring re-installation/remediation and the one or more re-installed/remediated piles in preparation for torque tube installation.

In one or more embodiments, aspects of the present patent document may be directed to, may include, or may be implemented on one or more computing systems. A computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read-only memory (ROM), and/or other types of memory. Additional components of the computing system may include one or more drives (e.g., hard disk drive, solid-state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

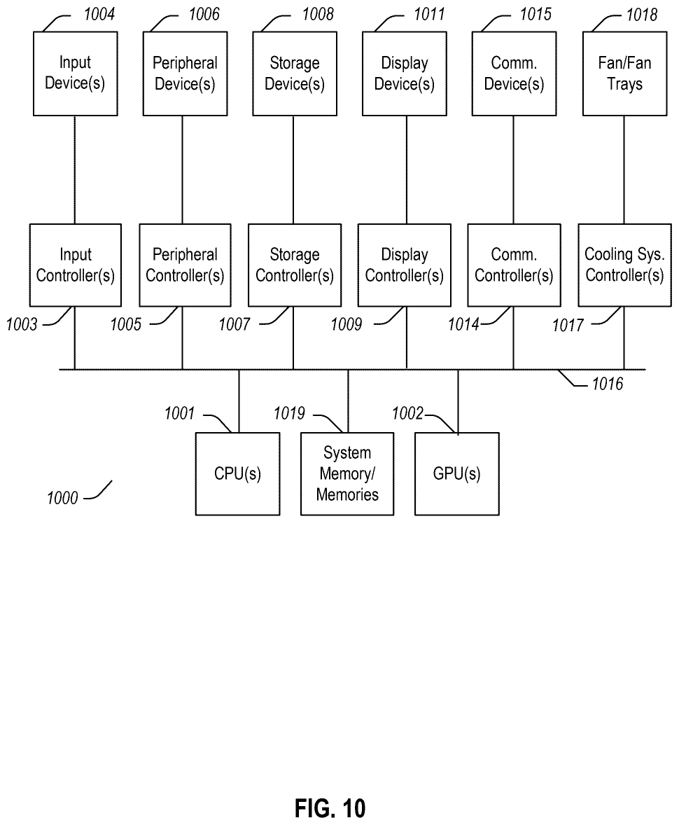

FIG. 10 depicts a simplified block diagram of a computing system, according to embodiments of the present disclosure. It will be understood that the functionalities shown for system 1000 may operate to support various embodiments of a computing system—although it shall be understood that a computing system may be differently configured and include different components, including having fewer or more components as depicted in FIG. 10.

As illustrated in FIG. 10, the computing system 1000 includes one or more CPUs 1001 that provide computing resources and control the computer. CPU 1001 may be implemented with a microprocessor or the like, and may also include one or more graphics processing units (GPU) 1002 and/or a floating-point coprocessor for mathematical computations. In one or more embodiments, one or more GPUs 1002 may be incorporated within the display controller 1009, such as part of a graphics card or cards. The system 1000 may also include a system memory 1019, which may comprise RAM, ROM, or both.

A number of controllers and peripheral devices may also be provided, as shown in FIG. 10. An input controller 1003 represents an interface to various input device(s) 1004. The computing system 1000 may also include a storage controller 1007 for interfacing with one or more storage devices 1008 each of which includes a storage medium such as magnetic tape or disk, or an optical medium that might be used to record programs of instructions for operating systems, utilities, and applications, which may include embodiments of programs that implement various aspects of the present disclosure. Storage device(s) 1008 may also be used to store processed data or data to be processed in accordance with the disclosure. The system 1000 may also include a display controller 1009 for providing an interface to a display device 1011, which may be a cathode ray tube (CRT) display, a thin film transistor (TFT) display, organic light-emitting diode, electroluminescent panel, plasma panel, or any other type of display. The computing system 1000 may also include one or more peripheral controllers or interfaces 1005 for one or more peripherals 1006. Examples of peripherals may include one or more printers, scanners, input devices, output devices, sensors, and the like. A communications controller 1014 may interface with one or more communication devices 1015, which enables the system 1000 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1000 comprises one or more fans or fan trays 1018 and a cooling subsystem controller or controllers 1017 that monitors thermal temperature(s) of the system 1000 (or components thereof) and operates the fans/fan trays 1018 to help regulate the temperature.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

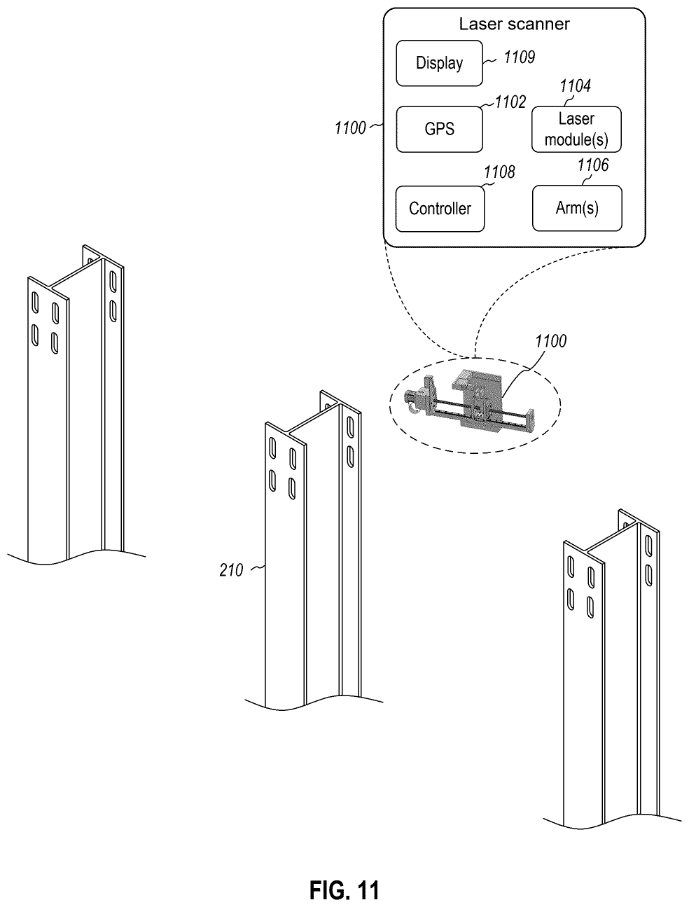

FIG. 11 is a schematic of a laser marker for pile marking in proximity to a pile in accordance with various embodiments of the invention. Before torque tube installation, each pile needs to have a plumb measurement to ensure the pile is adequately vertical in both longitudinal orientation (an orientation for torque tube lengthwise) and transverse direction (an orientation perpendicular to the longitudinal orientation). The plumb measurement may be done using a digital level. The plumb measurement may be calculated as part of 3D scan and subsequent fit of the point cloud to the pile shape. Piles with measurement results beyond a threshold (e.g., 5° deviation from perfect vertical angle or location deviation larger than the allowable threshold, or a height deviation larger than a threshold) may normally be remediated by “bumping” back within the threshold with a heavy piece of equipment, e.g., a skid steer or a telehandler. Only in the extreme cases where piles are beyond threshold significantly will the piles have to be reinstalled.

In one or more embodiments, the laser marker 1100 may comprise a Global Positioning System (GPS) sensor 1102 to identify scanner location, one or more laser modules 1104 for pile marking, one or more arms 1106 for supporting the laser modules, a controller 1108 to control the laser modules to desirable position(s) for pile marking operation, and optionally a display or screen 1109 to display details such as pile ID, one or more offset parameters for height, E-W, N-S and yaw adjustment.

When the laser marker 1100 is placed on or in proximity to a pile 210, the laser marker 1100 may identify the pile based on GPS location. The laser marker 1100 may first identify the geographic location of itself using the GPS sensor 1102. Afterwards, the laser marker 1100 may locate a pile within a distance threshold (e.g., 3 ft. yard or 1 meter) to the laser marker 1100 via a pile database that is established via pile scanning and validation steps described above. The pile database comprises 3D location of a center point, rotation information (roll, pitch and yaw), and one or more offsets of each pile. The pile database is compared to a digital twin that is a digital representation of the designed pile layout in the solar system field. The one or more offsets are used for a best-fit solar table installation and may comprise linear offset and/or angular offsets (e.g., twist angle offset, tilt angle offset, etc.). The piles are typically spaced minimum 5 meters apart. Therefore, a GPS signal with relatively coarse accuracy may be adequate to locate a correct pile in the digital twin in proximity to the actual location of the laser marker 1100.

The digital twin of the piles may be in a local file or in a cloud accessible by the laser marker 1100 for pile identification and offsets fetching. The laser marker 1100 may transmit its location to a cloud service that performs pile identification and then sends the information about the identified pile, e.g., a pile identification (X-th on Y-th row) as well as applicable offsets of the pile back to the laser marker 1100.

Once the pile is identified, the laser marker may be installed and operated for pile marking. Information for the identified pile may be rendered on the display 1109. The information may comprise pile ID, one or more offset parameters for height, E-W/N-S/yaw adjustment, etc.

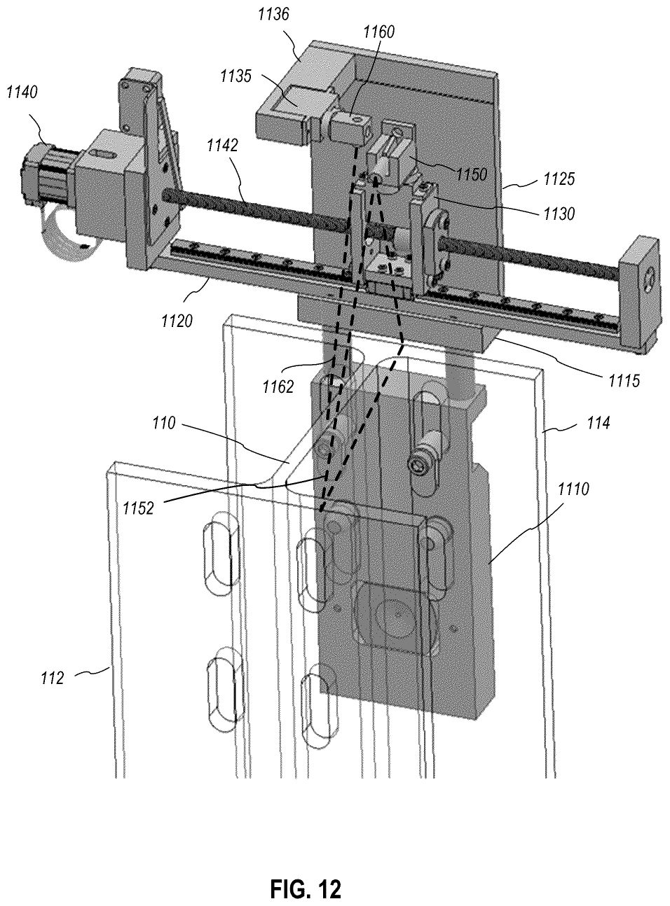

FIG. 12 is a perspective view of a laser marker installed on a pile for pile marking in accordance with various embodiments of the invention. The laser marker 1100 comprises a mounting plate 1110, a base 1115 coupled to the mounting plate 1110, a sliding rail 1120 supported by the base, a linear stage 1130 that is slidable along the sliding rail, a stepper motor 1140 that controls the position of the linear stage 1130, a first laser module 1150 placed on the linear stage, a second laser module 1160 supported by the base via a vertical plate. The second laser module 1160 and the first laser module 1150 may be controlled independently or collaboratively for laser projection operations.

In one or more embodiments, the stepper motor 1140 is a step motor that rotates a threaded rod 1142 to control the position of the linear stage 1130. As shown in FIG. 11, the pile marker may have a microcontroller that controls the position of the laser modules via the stepper motor, as well as controls the GPS and wireless communication (if enabled). As shown in FIG. 12, the pile 110 is an H-profile pile having two flanges 112 and 114. The mounting plate 1110 may be attached to one flange 404 with two hooks engaging the two top slots and two aligning/guiding pins engaging the two lower slots. The hooks might be actuated to actively hold tight to the pile or might be passive hooks. The attachment method for other piles with holes instead of slots will differ. The stepper motor 1140 rotates a threaded rod 1142 to move the linear stage 1130 to a center location along the flange 404 such that the first laser module 1150 can emit a first laser projection 1152 at a desired position. Furthermore, the first laser module 1150 may be rotatable on the linear stage 1130 for a desired twist angle such that the first laser projection 1152 may be in line with a twist offset angle of the pile.

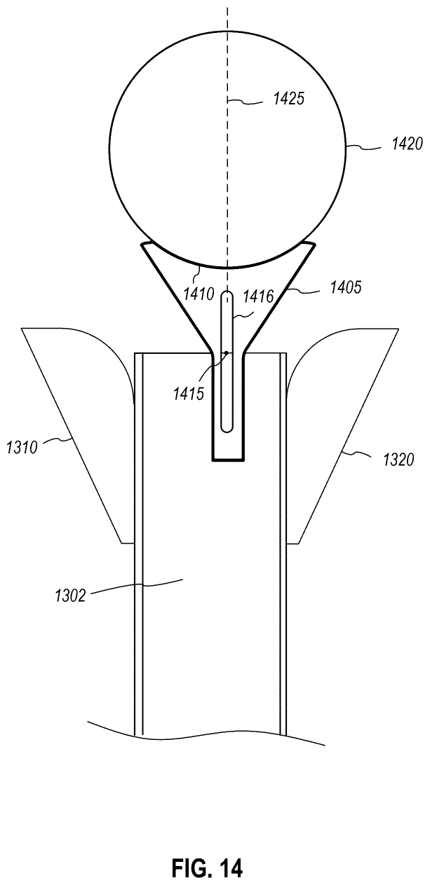

The first laser module 1150 may also be referred to as a north-south (N-S) location laser module, while the second laser module 1160 may also be referred to as an east-west (E-W) location laser module. The N-S direction is referred to as a direction along the pile row hereinafter. In one or more embodiments, the first laser projection 1152 is a line laser for bracket installation alignment, as disclosed in FIG. 13 with further details. The second laser projection 1162 is a dot laser that is used for longitudinal torque tube center line alignment. The first laser projection 1152 and the second laser projection 1162 may be powerful enough to etch or engrave the pile surface for direct and permanent markings. Alternatively, the first laser projection 1152 and the second laser projection 1162 may be used for marking reference on pile surface such that a paint may be applied to the pile surface. The marks on the pile may comprise a center line mark (e.g., the mark 1415 as described in FIG. 14) and one or more twist mark (e.g., the mark 1313/1314 as described in FIG. 13).

In one or more embodiments, the second laser module 1160 may be mounted in a rotational stage 1135 that provides guidance for the torque tube centerline location. The rotational stage 1135 may be supported on a cantilever 1136 that is anchored on a back plate 1125 coupled to the base 1115. Alternatively, the second laser module 1160 may be mounted in a second linear stage to correct an offset of a linear displacement for the torque tube installation. Although two different laser modules are show in FIG. 12, one skilled in the art shall understand that the laser marker may be configured using a single laser module to output a laser projection, a beam splitter to split the laser projection into two laser beams, and two prisms that direct the two laser beams on appropriate location on E-W and N-S directions respectively.

FIG. 13 is a top view of a pair of BHA brackets installed on a pile to compensate for a twist offset in accordance with various embodiments of the invention. When the pile 1302 in a row is twisted, subsequent bracket installation on the pile needs to be adjusted to compensate for the twist, otherwise the bearing housing mounted on the pile may be not in a straight line with bearing housings mounted on other piles. The twist offset may be defined as an angle θ between a pile centerline 1342 (between the pile flanges) and a centerline 1340 of torque tubes to be installed. Under an ideal situation, the angle θ shall be zero. The twist offset of the pile 1302 may be fetched from the digital twin once the laser marker 1100 is within a distance threshold to the pile.

Based on the twist offset of the pile, a first twist mark 1313 and a second twist mark 1314 are marked on the first flange 1303 and the second flange 1304, respectively, to compensate for the pile twist. The first twist mark 1313 and the second twist mark 1314 may be marked directly by the first laser projection 1152 emitted from the first laser module 1150 or by a paint indicated by the first laser projection 1152 on the flanges of the pile.

A virtual connection line 1315 of the twist marks is perpendicular to a longitudinal center line 1340 of torque tubes determined according to a best fit solar table installation scheme on the plurality of piles. The BHA brackets 1310 and 1320 are installed onto the pile 1302 according to the twist marks 1313 and 1314. A center line 1330 connecting the BHA brackets shall be aligned and parallel to the connection 1315 of the twist marks, as shown in FIG. 13. Such bracket installation ensures that subsequently installed torque tubes are aligned without twist.

Once the BHA bracket installation on the piles is completed, subsequent solar table installation may start. FIG. 14 depicts solar table alignment verification in accordance with various embodiments of the invention. A solar table to be installed shall be centered above a center line mark 1415, which may be marked directly by the second laser projection 1162 emitted from the second laser module 1160 or by a paint indicated by the second laser projection 1162 on top of the pile.

A table alignment may be verified using a centering jig 1405, which has a curved top 1410 and a jig slot 1416 below the curved top in the middle. The curved top 1410 has a curvature matching the torque tube 1420 in the solar table. When the centering jig 1105 is vertically placed under the torque tube 1420, a cross-sectional center line 1425 of the torque tube is aligned to the jig slot 1416. If the line mark 1415 is visible through the jig slot 1416, the torque tube and thus the solar table is aligned correctly and can be securely mounted onto the brackets 1310 and 1320. If the line mark 1415 is not visible through the jig slot 1416, the solar table is not aligned correctly and an adjustment for the solar table or torque tube may be needed. For example, the torque may be pushed or pulled horizontally until the center line mark 1415 becomes visible.

Although FIG. 14 shows a centering jig with a jig slot for alignment verification, one skill in the art shall understand that various other configurations, such as a transparent centering jig with a marked zone, may also be used. Such variations shall also be within the scope of the present invention.

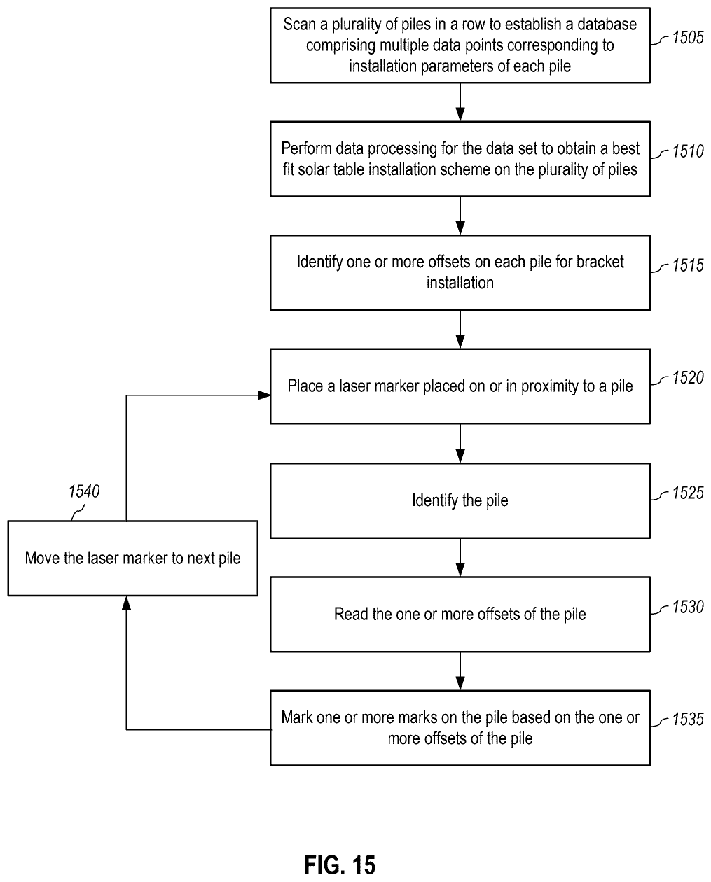

FIG. 15 is a process of pile marking in accordance with various embodiments of the invention. In step 1505, a plurality of piles in a row are scanned to obtain a pile database comprising multiple data points corresponding to installation parameters of each pile. The scanning may be performed using a 3D LIDAR scanner. The multiple data points may comprise one or more installation parameters for each pile, e.g., pile positions in x, y, and z coordinates, pile roll, pile pitch, pile yaw, etc.,

In step 1510, data processing is performed for the pile database is processed to obtain a best fit solar table installation scheme on the plurality of piles. In step 1515, one or more offsets are identified on each pile for bracket installation based on the best fit solar table installation scheme. The one or more offsets may comprise linear offset and/or angular offsets (e.g., twist angle offset, tilt angle offset, etc.) with respect to a default bracket installation position on each pile.

In step 1520, a laser marker is placed on or in proximity within a distance threshold to a pile among the plurality of pile. The laser marker may have a built-in GPS sensor to automatically identify the location of the laser marker. In step 1525, the pile is identified based on the location of the laser marker via the pile database, which may be pre-loaded to the laser marker or remotely accessible (e.g., in a cloud) by the laser marker. The pile being identified is the pile having the least distance to the laser marker among the plurality of piles.

In step 1530, based on the identification of the pile, the one or more offsets of the pile are read. In step 1535, one or more marks are marked on the pile based on the one or more offsets of the pile as disclosed in FIGS. 12-14 and corresponding description. In step 1540, the laser marker is moved to another pile to repeat the operations in steps 1520-1530, until all piles are properly marked.

It will be appreciated by those skilled in the art that the preceding examples and embodiments are exemplary and not limited to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claim may be arranged differently including having multiple dependencies, configurations, and combinations.

What is claimed is:

1. A method of pile marking for solar table installation, the method comprising:
placing a laser marker onto or within a distance threshold to a pile among a plurality of piles in a row;
identify, via a pile database that comprises location information of the plurality of piles, the pile based on a location of the laser marker, the pile being identified is the pile having the least distance to the laser marker among the plurality of piles;
reading, from the pile database, one or more offsets of the pile being identified, the one or more offsets are used for a solar table installation scheme on the plurality of piles; and
marking, using the laser marker, one or more marks on the pile based on the one or more offsets.

2. The method of claim 1, wherein the one or more offsets comprise one or more linear offset and one or more angular offsets with respect to a default bracket installation position on the pile.

3. The method of claim 1, wherein the laser marker comprises:
a mounting plate attached to the pile;
a sliding rail coupled to the mounting plate;
a linear stage that is slidable along the sliding rail;
a first laser module placed on the linear stage; and
a controller that controls the positions of the linear stage and the first laser module.

4. The method of claim 3, wherein the first laser module emits a first laser projection onto a first flange and a second flange of the pile to mark a first twist mark and a second twist mark on the first flange and the second flange, respectively, the first twist mark and the second twist mark are among the one or more marks on the pile.

5. The method of claim 4, wherein the first twist mark and the second twist mark have a virtual connection line perpendicular to a longitudinal center line of torque tubes determined according to the solar table installation scheme on the plurality of piles.

6. The method of claim 3, wherein the laser marker further comprises a second laser module that emits a second laser projection onto the pile to mark a center line mark on the pile, the center line mark is among the one or more marks on the pile.

7. The method of claim 6, wherein the center line mark is aligned to a cross-sectional center line of torque tubes to be installed according to the solar table installation scheme.

8. The method of claim 1, wherein the pile database is established during a scanning of the plurality of the piles.

9. The method of claim 1, wherein the pile database is pre-loaded to the laser marker or remotely accessible by the laser marker.

10. The method of claim 1, further comprising:
mounting one or more brackets on the pile according to the one or more marks.

11. A laser marker for pile marking to facilitate solar table installation, the laser marker comprising:
a GPS sensor to locate the position of the laser marker;
a mounting plate to attach the laser marker to a pile among a plurality of piles in a row, the pile is identified based on the position of the laser marker using a pile database that comprises location information of the plurality of piles; and
one or more laser modules that are operated to emit one or more laser projections onto the pile to mark one or more marks on the pile for bracket installation, the one or more marks are marked based on one or more offsets on the pile with respect to a default bracket installation position on the pile, the one or more offsets are determined according to a solar table installation scheme on the plurality of piles.

12. The laser marker of claim 11 further comprising:
a sliding rail coupled to the mounting plate;
a linear stage that is slidable along the sliding rail; and
a first laser module, among the one or more laser modules, placed on the linear stage to emit a first laser projection on the pile.

13. The laser marker of claim 12, wherein the first laser projection is a line laser for bracket installation alignment.

14. The laser marker of claim 12, wherein the first laser projection is projected on a first flange and a second flange of the pile to respectively mark a first twist mark and a second twist mark, among the one or more marks.

15. The laser marker of claim 14, wherein the first twist mark and the second twist mark have a virtual connection line perpendicular to a longitudinal center line of torque tubes determined according to the solar table installation scheme on the plurality of piles.

16. The laser marker of claim 14, wherein the first twist mark and the second twist mark are marked by the first laser projection directly or by a paint mark indicated by the first laser projection on the first and second flanges of the pile.

17. The laser marker of claim 12 further comprising:
a first laser module, among the one or more laser modules, coupled to the mounting plate to emit a second laser projection on the pile.

18. The laser marker of claim 17, wherein the second laser projection is a dot laser to mark a center line mark, among the one or more marks, on the pile for longitudinal torque tube center line alignment.

19. The laser marker of claim 17, wherein the center line mark is aligned to a cross-sectional center line of torque tubes to be installed according to the solar table installation scheme.

20. The laser marker of claim 17, wherein the center line mark is marked by the second laser projection directly or by a paint mark indicated by the second laser projection on the pile.
